(19) United States
(12) Patent Application Publication
(10) Pub. No.: US 2014/0092018 A1
(43) Pub. Date: Apr. 3, 2014

(54) NON-MOUSE CURSOR CONTROL INCLUDING MODIFIED KEYBOARD INPUT

(71) Applicant: Ralf Wolfgang Geithner, Schwetzinger (DE)

(72) Inventor: Ralf Wolfgang Geithner, Schwetzinger (DE)

(21) Appl. No.: 13/630,599

(22) Filed: Sep. 28, 2012

(51) Int. Cl. G06F 3/02; G09G 5/08

(52) U.S. Cl. 345/160

(57) ABSTRACT

The disclosure generally describes computer-implemented methods, software, and systems for modeling and deploying decision services. One computer-implemented method includes displaying a graphical user interface not including a cursor on a display device. An interaction with a first key of a keyboard is received, the first key being associated with display of the cursor. Based on receiving the interaction with the first key, the cursor is displayed with the graphical user interface on the display device. In response to displaying the cursor with the graphical user interface on the display device, non-mouse cursor control inputs of a user are tracked. The cursor is moved on the display device based on the tracked non-mouse cursor control inputs of the user.

### BACKGROUND

Non-mouse cursor control technologies allow a user to control the user interface of a computing device without the use of a mouse. For example, eye tracking technologies allow a user to control the user interface of a computing device with eye movement. These non-mouse cursor control technologies can be used to supplement or even supplant one or more of the existing user interfaces. For example, eye tracking technologies may perform functions to replace a mouse pointing device by converting a user's eye movement into movement of a cursor displayed on a display device of the computing device. Similarly, brain tracking technologies, such as electroencephalography (EEG), may perform functions to replace a mouse pointing device by converting a user's brain activity into movement of a cursor displayed on the display device of the computing device.

### SUMMARY

The present disclosure relates to computer-implemented methods, software, and systems for non-mouse cursor control including modified keyboard input. One system includes displaying a graphical user interface not including a cursor on a display device. An interaction with a first key of a keyboard is received, the first key being associated with display of the cursor. Based on receiving the interaction with the first key, the cursor is displayed with the graphical user interface on the display device. In response to displaying the cursor with the graphical user interface on the display device, non-mouse cursor control inputs of a user are tracked. The cursor is moved on the display device based on the tracked non-mouse cursor control inputs of the user.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by a data processing apparatus, cause the apparatus to perform the actions.

The foregoing and other implementations can each optionally include one or more of the following features: tracking non-mouse cursor control inputs of a user may include tracking eye movements of a user and moving the cursor on the display device based on the tracked non-mouse cursor control inputs of the user may include moving the cursor on the display device based on the tracked eye movements of the user. The method may further comprise receiving another interaction with the first key of the keyboard and removing display of the cursor from the display device. Receiving the interaction with the first key of the keyboard may include receiving a continuous selection of the first key indicative of the user holding the first key down. Receiving the interaction with the first key of the keyboard may include receiving a continuous selection of the first key indicative of the user holding the first key down.

Receiving the interaction with the first key of the keyboard may include receiving an indication of a press and release of the first key. Receiving another interaction with the first key of the keyboard may include receiving an indication of another press and release of the first key. Displaying the cursor with the graphical user interface on the display device may include determining an active element of the graphical user interface displayed on the display device and displaying the cursor at a center of the active element of the graphical user interface. The keyboard may include a second key associated with a first type of selection with the cursor and a third key associated with a second type of selection with the cursor.

The second key of the keyboard and the third key of the keyboard may each be associated with one of a right click with the cursor or a left click with the cursor. The keyboard may be a standard QWERTY keyboard and the first key, the second key, and the third key may be additional keys that are each dedicated to a single function. The keyboard may be a standard QWERTY keyboard and the first key, the second key, and the third key may be keys standard to a QWERTY keyboard. Receiving the selection of the first key of the keyboard may include receiving the selection of the first key of the keyboard concurrently with selection of a fourth key, the fourth key causing an alternate function of the first key. Tracking non-mouse cursor control inputs of a user may include tracking brain activity of a user. Moving the cursor on the display device based on the tracked non-mouse cursor control inputs of the user may include moving the cursor on the display device based on the tracked brain activity of the user.

The subject matter described in this specification can be implemented in particular implementations so as to realize one or more of the following advantages. First, the proposed keyboard layout and cursor control system obviate the need for a mouse point device, reducing the number of peripherals necessary to operate a computing device. Second, the cursor control methods described herein allow a user to concentrate on the graphical user interface (GUI) displayed by the computing device without distraction from the cursor always following the user's attention/gaze. Third, when a user activates cursor display, the cursor control methods described herein cause the cursor to be initially displayed near the active GUI element (e.g., window) being displayed by the computing device, reducing the time necessary to move the cursor where the user desires. Fourth, by only tracking non-mouse cursor control inputs when a cursor is displayed by the computing device, processing efficiency may be improved. Fifth, by replacing the mouse with the three keys on the keyboard as proposed herein, the ergonomics may be increased. Such ergonomic improvements may reduce mouse-induced negative health effects like repetitive strain injury (RSI) syndrome, which is a typical office-worker occupational disease.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for non-mouse cursor control including modified keyboard input.

FIG. 2 is a diagram illustrating an example keyboard layout facilitating non-mouse cursor control.

FIG. 3 is a flow chart for non-mouse cursor control including modified keyboard input.

FIG. 4 is a flow chart for determining an initial location of a cursor upon cursor display.

Like reference numbers and designations in the various drawings indicate like elements.

### DETAILED DESCRIPTION

This disclosure generally describes computer-implemented methods, software, and systems for non-mouse cursor control including modified keyboard input.

For illustration purposes, the various implementations described herein will be described with regard to a computing system that detects a user's interaction with a keyboard, tracks non-mouse cursor control inputs, and controls the display of a cursor on a display device of the computing system based on the keyboard interaction and non-mouse cursor control inputs. The described computing system may be applied to any computer system requiring user control of one or more elements graphical elements displayed by the computer system. For example, the computer system may be a desktop computer, laptop computer, mobile telephone, personal data assistant (PDA), tablet computer, or any other mobile or non-mobile computing device. Moreover, the keyboard described herein can include a stand-alone physical keyboard, a physical keyboard integral to the computing device, or a virtual keyboard displayed by a computing device. Additionally, the described keyboard and cursor control systems and methods may be used with any non-mouse cursor control technology.

Though, for ease of explanation, description will be made primarily with regard to camera-based eye tracking technology, other non-mouse cursor control technologies are equally applicable to the described computer-implemented methods, software, and systems. For example, brain tracking technologies, such as electroencephalography (EEG), may be used in conjunction with the modified keyboard inputs described herein to control the movement of a cursor displayed on a display device of a computing system.

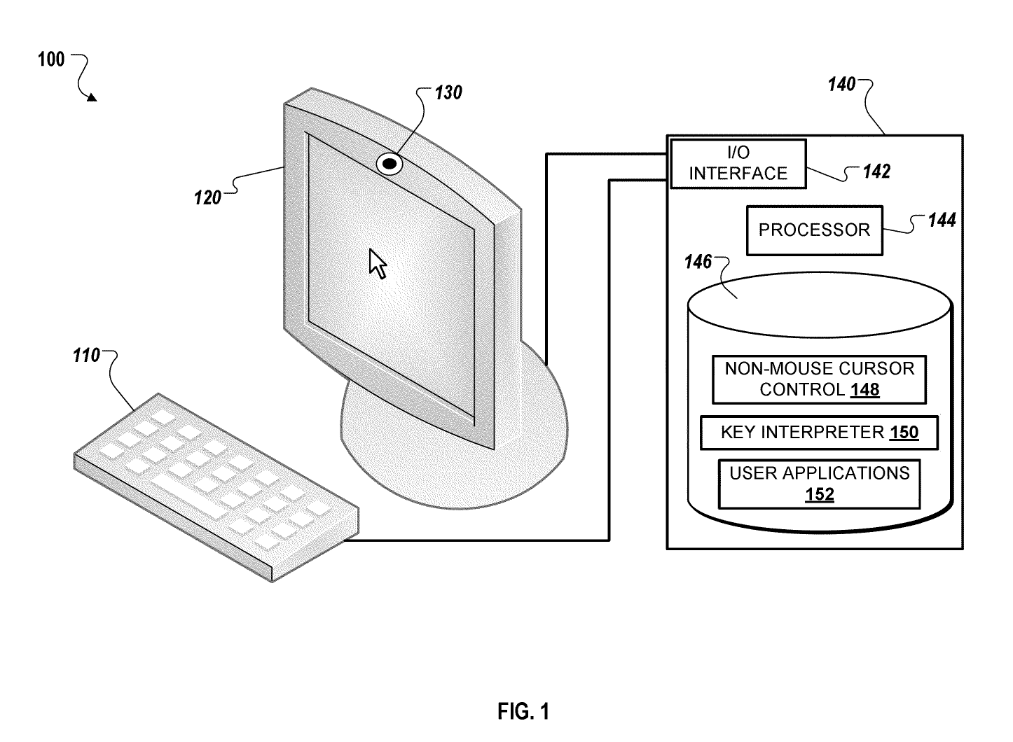

FIG. 1 illustrates an example system for non-mouse cursor control including modified keyboard input. At a high-level, the illustrated example computing system 100 includes or is communicably coupled with a keyboard 110, a display device 120, a camera 130, and a computing device 140. Keyboard 110, display device 120, camera 130, and computing device 140 may be physically separate devices or combined into one or more devices. For example, in a case where the computing system 100 is a laptop computer, each of the keyboard 110, the display device 120, the camera 130, and the computing device 140. Alternatively, each of the keyboard 110, the display device 120, the camera 130, and the computing device 140 may be separate devices connected in a wired or wireless manner. Moreover, though the camera 130 is illustrated as being integrated into the display device 130, the camera 130 may be a separate device. In some implementations, the computing system 100 does not include a mouse pointing device, as the functionality of a mouse pointing device may be accomplished by the other components of the computing system 100, as will be described below.

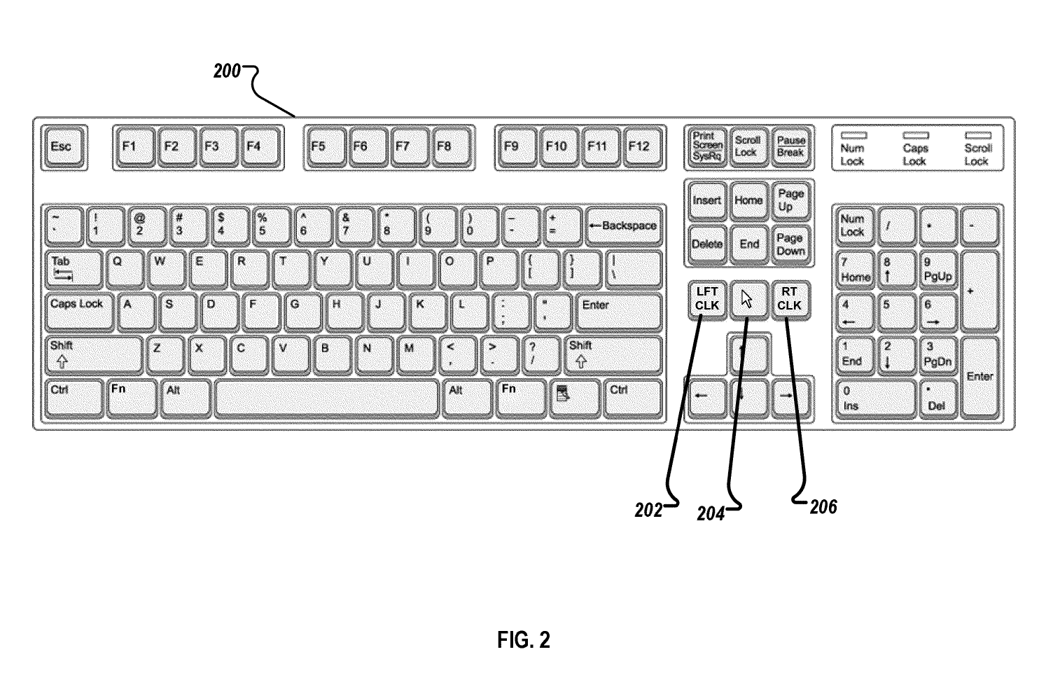

As described above, keyboard 110 may be a physical or virtual keyboard integrated into one or more of the other components of computing system 100 or separate from them. In some implementations, the keyboard 110 may be a standard QWERTY keyboard that includes three additional dedicated keys associated with cursor-related functionality. FIG. 2 illustrates an example of a standard QWERTY keyboard that includes three additional dedicated keys associated with cursor-related functionality.

As shown in FIG. 2, a standard QWERTY keyboard 200 may include three additional, dedicated keys 202, 204, and 206. Dedicated key 202 is associated with a first type of selection with a cursor displayed on the display device 120. In some implementations, the first type of selection is a “left-click” operation that would normally result from a user interacting with a left mouse button on a standard two-button mouse. Dedicated key 206 is associated with a second type of selection with a cursor displayed on the display device 120. In some implementations, the second type of selection is a “right-click” operation that would normally result from a user interacting with a right mouse button on a standard two-button mouse.

Dedicated key 204 is associated with display of a cursor on the display device 120. In some implementations, when a user interacts with dedicated key 204 (e.g., presses and releases dedicated key 204 or presses and holds dedicated key 204), a cursor is displayed on the display device 120. When a user interacts with the dedicated key 204 again (e.g., presses and releases dedicated key 204 again or discontinues holding dedicated key 204), the cursor is hidden from display on the display device 120. In some implementations, the cursor is not displayed on the display device 120 until a user interacts with dedicated 204. Moreover, processes associated with non-mouse cursor control begin execution after a user interacts with dedicated key 204 and the cursor is displayed and execution of the processes associated with non-mouse cursor control ceases after a user again interacts with dedicated key 204 and the cursor is hidden. In other words, in some implementations, processes associated with non-mouse cursor control are only executed when a cursor is displayed on the display device 120.

In FIG. 2, dedicated keys 202, 204, and 206 are located under the “Insert”, “Home”, “Page Up”, “Page Down”, “End”, and “Delete” keys. However, the dedicated keys 202, 204, and 206 may be located anywhere on keyboard 200. Moreover, in some implementations, the keys 202, 204, and 206 may be standard keys that are not dedicated to the above-described functionality. The keys 202, 204, and 206 may instead implement the above-described cursor-related functionality as an alternate function to a standard key function. For example, keys 202, 204, and 206 may be the “left arrow”, “down arrow”, and “right arrow” keys present on standard QWERTY keyboards. To initiate the above-described cursor-related functionality, a user may concurrently interact with another key on the keyboard (e.g., the “control,” “function,” or “shift” key) while interacting with one of the keys 202, 204, or 206.

Though the keyboard 200 has been described as a physical keyboard, the keyboard 200 may be a virtual keyboard displayed on the display device 120. For example, in an implementation where the computing system 100 is a tablet computer and display device 120 is a touch screen, the display device 120 may be configured to display a virtual representation of keyboard 200 and the display device 120 may detect a user's interaction with keys 202, 204, or 206.

Returning to FIG. 1, camera 130 may be integrated with display device 120 (as shown in FIG. 1) or it may be separate from display device 120. Camera 130 may be configured to operate in conjunction with computing device 140 to capture images of a user of the computing system 100 and track the eye movements of the user. In some implementations, camera 130 may be replaced by or supplemented with one or more other devices related to non-mouse cursor control. For example, the camera 130 may be replaced by or supplemented with skin electrodes around the eye, an infrared light beam configured to shine at a user's eye, or special contact lenses placed in a user's eye(s). Alternatively or additionally, the camera 130 may be replaced by or supplemented with brain tracking technologies, such as electroencephalography (EEG).

Computing device 140 includes an interface 142. Although illustrated as a single interface 142 in FIG. 1, two or more interfaces 142 may be used according to particular needs, desires, or particular implementations of the example computing system 100. The interface 142 is used by the computing device 140 for communicating with other systems in a distributed environment—including within the example computing system 100—connected to the keyboard 110, display device 120, and/or camera 130. Generally, the interface 142 comprises logic encoded in software and/or hardware in a suitable combination and operable to communicate with the keyboard 110, display device 120, and/or camera 130. More specifically, the interface 142 may comprise software supporting one or more communication protocols associated with communications one or more networks or other peripherals connected to computing system 100.

The computing device 140 includes a processor 144. Although illustrated as a single processor 144 in FIG. 1, two or more processors may be used according to particular needs, desires, or particular implementations of the example computing system 100. Generally, the processor 144 executes instructions and manipulates data to perform the operations of the computing device 140. Specifically, the processor 144 executes the functionality required to process inputs from the keyboard 110 and camera 130 to track non-mouse cursor control input and translate the non-mouse cursor control input into movement of a cursor displayed on the display device 120.

The computing device 140 includes a memory 146 application, data, and/or instructions associated with the operation of the computing system 100. For example, in some implementations, the memory 146 may store a non-mouse cursor control component 148, a key interpreter component 150, and one or more user applications 152. The non-mouse cursor control component 148, key interpreter component 150, and one or more user applications 152 may be a single set of instructions or functions, a single application, multiple sets of instructions or functions, or multiple applications. In some implementations, the processor 144 may be configured to execute the non-mouse cursor control component 148, key interpreter component 150, and one or more user applications 152. Alternatively, in some implementations, non-mouse cursor control component 148, key interpreter component 150, and the one or more user applications 152 may be implemented in hardware or a combination of hardware and software.

The non-mouse cursor control component 148 interprets input from camera 130 and/or other hardware associated with computing system 100 to track a user's non-mouse cursor control inputs. The non-mouse cursor control component 148 may employ any known non-mouse cursor control technology. For example, in some implementations, camera 130 may be positioned to facilitate the capture of images of a user's face. The non-mouse cursor control component 148 may receive the images captured by the camera 130 to track a user's eye movement within the captured images and determine the point on the display device 120 at which the user's gaze is focused. Alternatively, in some implementations, skin electrodes may be placed around a user's eye(s) and the non-mouse cursor control component 148 may interpret signals received from the skin electrodes to determine potential differences representative of eye position. Alternatively, in some implementations, an infrared light beam may be directed at a user's eye and the non-mouse cursor control component 148 may measure the angular difference between the user's mobile pupil and the stationary light beam reflection. In some implementations, non-mouse cursor control component 148 may utilize one or more of these non-mouse cursor control technologies to determine the point on the display device 120 at which the user's attention/gaze is focused.

The key interpreter 150 receives, through interface 142, inputs from the keyboard 110 and translates the inputs into interactions with, for example, the one or more user applications 152. In some implementations, the key interpreter 150 may be configured to determine whether a user has interacted with one of dedicated keys 202, 204, or 206 of keyboard 200. In these implementations, key interpreter 150 may be configured to initiate a standard left-click operation when the key interpreter 150 receives an indication that a user has interacted with key 202, display or hide a cursor on the display device 120 when the key interpreter 150 receives an indication that a user has interacted with key 204, and/or initiate a standard right-click operation when the key interpreter 150 receives an indication that a user has interacted with key 206.

The one or more user applications 152 may be any applications and/or functions that may be executed by computer device 140, including applications or functions that generate one or more GUIs that are displayed on the display device 120. For example, the one or more user applications 152 may include an internet browser, a word processing application, a calculator, a image/video editing application, and/or an e-mail client. In some implementations, the one or more GUIs that are displayed on the display device 120 by the one or more user applications 152 may include one or more window-type GUI components. In some implementations, the one or more user applications 152 may include an operating system configured to facilitate display of the one or more GUIs and/or one or more GUI components on the display device 120.

When the computing device 140 causes more than one GUI component to be displayed on the display device 120, one of the GUI components may be designated as active. In some implementations, the GUI components may be displayed in a layered fashion such that one or more of the GUI components overlap each other and the GUI component designated as active may be the GUI component displayed as the “highest” visual layer. For example, the computing device 140 may cause a window associated with a web-browsing user application and a window associated with a word processing user application to be displayed concurrently on the display device 120 and the window associated with the web-browsing user application may overlap the window associated with the word processing user application. In this example, the window associated with the web-browsing user application may be designated as the active GUI component, because it overlaps the window associated with the word processing user application and is accordingly at the “highest” visual layer. Alternatively, in some implementations, the GUI component most recently interacted with by a user may be designated as active.

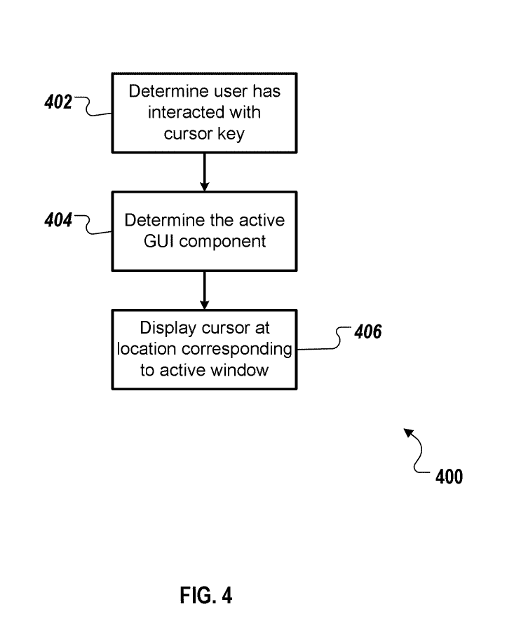

As will be described below with regard to FIG. 4, when key interpreter 150 causes a cursor to be displayed on display device 120, key interpreter 150 may cause the cursor to be initially displayed at or near the active GUI component. By initially displaying the cursor at or near the active GUI component, key interpreter 150 may reduce the amount of time necessary for a user to navigate the cursor to a desired position on the display device 120. The cursor displayed by the key interpreter 150 on display device 120 may be any graphical representation that facilitates visual navigation functionality. For example, the cursor may be a graphical representation of an arrow, a hand, or a crosshair.

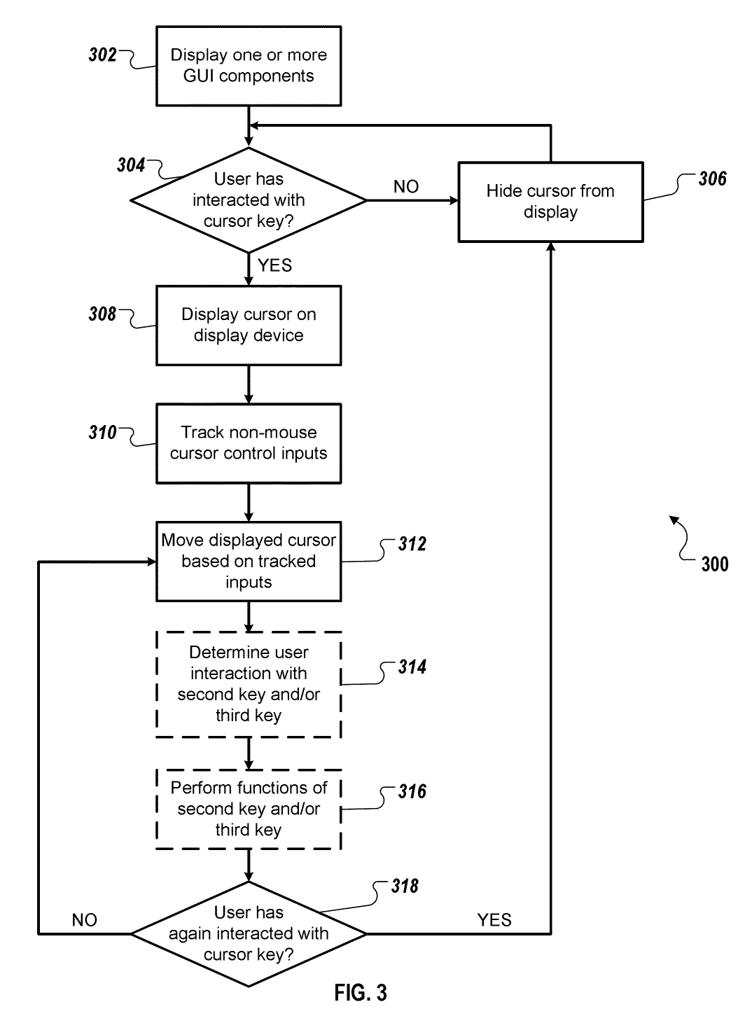

Turning now to FIG. 3, FIG. 3 illustrate a flow chart 300 for non-mouse cursor control including modified keyboard input. For clarity of presentation, the description that follows generally describes method 300 in the context of FIGS. 1 and 2. However, it will be understood that method 300 may be performed, for example, by any other suitable system, environment, software, and hardware, or a combination of systems, environments, software, and hardware as appropriate. For example, one or more of the keyboard, display device, camera, computing device, or other computing device (not illustrated) can be used to execute method 300 and obtain any data from the memory of the client, the keyboard, display device, camera, computing device, or the other computing device (not illustrated).

At 302, one or more user applications cause one or more GUI components to be displayed on a display device of a computing system. As described above, in some implementations, the one or more GUI components may be window-type GUI components. In some implementations the one or more GUI components may include text, menus, buttons, images and/or other graphical representations of data. The one or more GUI components may facilitate input from a user and/or output to a user from the one or more user applications. Initially, no cursor is displayed on the display device of the computing system.

In some implementations, where the one or more user applications include an operating system, the operating system may facilitate display of the one or more GUI components on the display device. For example, the operating system may provide an application programming interface (API) through which one or more other user applications may request display of one or more GUI components on the display device.

At 304, the key interpreter determines whether a user has interacted with one or more keys associated with display of a cursor on the display device. Specifically, the key interpreter receives, from the interface, an indication of an interaction with the key. In some implementations, the key interpreter analyzes the indication to determine whether a user has pressed and released the key. Alternatively, in some implementations, the key interpreter analyzes the indication to determine whether a user is continuously holding the key.

As described above, the key associated with display of a cursor on the display device may be a dedicated key or a key with shared functionality. In implementations where the key associated with display of a cursor on the display device is a key with shared functionality, the key interpreter may determine whether the indication that a user has interacted with the key is received concurrently with an indication that a user has interacted with one or more other keys (e.g., the shift, alt, or control keys). Additionally, the key interpreter may determine whether the concurrently received interactions should cause the cursor to be displayed. For example, the cursor display functionality may only be executed when a user has interacted with a specific combination of keys.

As long as the key interpreter determines that a user has not interacted in a specific manner with the key(s) associated with display of a cursor on the display device, operation proceeds to 306. At 306 the key interpreter causes the cursor to be or remain hidden from display on the display device. In some implementations, as long as the cursor is hidden from display, the computing device does not conduct any processing with regard to the cursor (e.g., eye tracking) beyond operation 304.

However, when the key interpreter determines that a user has interacted in a specific manner with the key(s) associated with display of a cursor on the display device, operation proceeds to 308. At 308, the key interpreter causes a cursor to be displayed on the display device. As will be described with regard to FIG. 4, in some implementations, the initial point at which the cursor is displayed may be determined based on the active GUI component being displayed on the display device.

At 310, the non-mouse cursor control component tracks the user's non-mouse cursor control inputs to determine the point on the display device at which the user's attention/gaze is focused. In some implementations, as long as the cursor is displayed on the display device, the non-mouse cursor control component will continue to determine the point on the display device 120 at which the user's attention/gaze is focused. The non-mouse cursor control component may use any known non-mouse cursor control technology to determine the point on the display device at which the user's gaze is focused. For example, the eye tracking component may utilize images captured by the camera, as well as data regarding the location of the camera and user with regard to the display device, to determine the point on the display device at which the user's gaze is focused. In some implementations, the non-mouse cursor control component utilizes inputs from alternative or additional hardware and/or software components to track the user's non-mouse cursor control.

As the non-mouse cursor control component detects a change in the point on the display device at which the user's attention/gaze is focused, at 312, the non-mouse cursor control component causes the cursor to move on the display device relative to the detected change in the user's attention/gaze. Moreover, as the cursor moves in relation to the detected change in the user's attention/gaze, the non-mouse cursor control component may “snap” the cursor to a prominent feature of a GUI component when the user's attention/gaze is determined to be in the area of the prominent feature (e.g., a button, a scroll bar, or a text field).

Though method 300 is described as an implementation in which the cursor is initially hidden from display on the display device, in alternative implementations, the cursor may initially be displayed on the display device. In these implementations, method 300 may skip directly from operation 302 to operation 308. In other words, when is initially displayed on the display device, the computing system may immediately begin tracking a user's non-mouse cursor control input (310) and move the cursors on the display device in correspondence with the tracked non-mouse cursor control input (312).

In some implementations, while the cursor is displayed on the display device and the computer system is tracking a user's non-mouse cursor control inputs, a user may interact with a first key associated with a first type of selection with a cursor displayed on the display device and/or a second key associated with a second type of selection with a cursor displayed on the display device. At 314, the key interpreter may receive an indication that a user has interacted with either the first key (e.g., key 202 of FIG. 2) or the second key (e.g., key 206 of FIG. 2). Based on receiving the indication that the user has interacted with either the first key or the second key, at 316, the key interpreter may cause execution of the first type of selection with the cursor or the second type of selection with the cursor, respectively. For example, the key interpreter may receive an indication that the user has interacted with the first key, and, as a result, the key interpreter may cause execution of a left-click operation at the point at which the cursor is displayed. In another example, the key interpreter may receive an indication that the user has interacted with the second key, and, as a result, the key interpreter may cause execution of a right-click operation at the point at which the cursor is displayed.

At 318, the key interpreter determines whether the user has again interacted with the key(s) associated with display of a cursor on the display device. As long as the key interpreter does not determine that the user has again interacted with the key(s), the non-mouse cursor control component continues detecting changes in the point on the display device at which the user's attention/gaze is focused and continues moving the cursor on the display device accordingly. However, when the key interpreter does determine that the user has again interacted with the key(s), the key interpreter return to 306, hiding the cursor from display on the display device.

In implementations where, at 304, the key interpreter analyzes the received indication of user interaction to determine whether a user has pressed and released the cursor key, key interpreter, at 318 again analyzes whether a user has pressed and released the cursor key. In other words, a user pressing and releasing the key(s) associated with display of a cursor on the display device causes the cursor to be displayed until the user again presses and releases the key(s). Alternatively, in implementations where, at 304, the key interpreter analyzes the received indication of user interaction to determine whether a user is continuously holding the cursor key, key interpreter, at 318 analyzes the other received indication to determine whether the user has released the key. In other words, a user pressing and continuously holding the key(s) associated with display of a cursor on the display device causes the cursor to be displayed until the user releases the key(s).

By only displaying the cursor when the user interacts with one or more specific keys, the user need not be distracted by continuous movement of the cursor to the point at which the user is focusing. For example, after a user has navigated to a specific webpage in a browser application using the cursor, the user may hide the cursor while the user reads the webpage so that the cursor does not continue to move around the screen as the user reads. Then, once the user is ready to again navigate the various GUIs and GUI components displayed on the display device using the cursor, the user may reactive the cursor.

Turning now to FIG. 4, FIG. 4 illustrates a flow chart 400 for determining an initial location of a cursor upon cursor display. For clarity of presentation, the description that follows generally describes method 400 in the context of FIGS. 1 and 2. However, it will be understood that method 400 may be performed, for example, by any other suitable system, environment, software, and hardware, or a combination of systems, environments, software, and hardware as appropriate. For example, one or more of the keyboard, display device, camera, computing device, or other computing device (not illustrated) can be used to execute method 400 and obtain any data from the memory of the client, the keyboard, display device, camera, computing device, or the other computing device (not illustrated).

At 402, the key interpreter determines that a user has interacted with the key(s) associated with display of a cursor on the display device. This determination may be made similar to the determination made at 304 in flow chart 300 or by any other known and suitable process.

At 404, the key interpreter determines the active GUI component. As described above, the key interpreter may determine that the GUI component that overlaps the other GUI components and is accordingly at the “highest” visual layer is the active GUI component. Alternatively, in some implementations, the key interpreter may determine that the GUI component most recently interacted with by a user is the active GUI component. In essence, the goal of operation 404 is to determine the GUI component that is likely of most interest to the user. Therefore, any technique for determining the GUI component that is likely of most interest to the user may be utilized.

At 406, the key interpreter causes the display device to display the cursor at a location corresponding to a location of the GUI component determined to be active in operation 404. In some implementations, for example, the key interpreter may cause the cursor to initially be displayed over the center of the GUI component determined to be active. In other implementations, the key interpreter may cause the cursor to initially be displayed at a corner of the GUI component determined to be active. By initially displaying the cursor at or near the active GUI component, the computer system may reduce the delay of moving the cursor to the user's most likely point of interest from an arbitrary initial point of display, since the user's non-mouse cursor control input ultimately determines the cursor position and the active GUI component is the most likely position at which the user's attention/gaze will be focused.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A system, comprising:
a keyboard including a first key associated with display of a cursor;
a display device;
one or more processors; and
one or more storage devices storing instructions that, when executed by the one or more processors, cause the one or more processors to perform operations including:
displaying a graphical user interface not including the cursor on the display device,
receiving an interaction with the first key of the keyboard,
based on receiving the interaction with the first key, displaying the cursor with the graphical user interface on the display device,
in response to displaying the cursor with the graphical user interface on the display device, tracking non-mouse cursor control inputs of a user, and
moving the cursor on the display device based on the tracked non-mouse cursor control inputs of the user.

2. The system of claim 1, wherein:
tracking non-mouse cursor control inputs of the user includes tracking eye movements of the user; and
moving the cursor on the display device based on the tracked non-mouse cursor control inputs of the user includes moving the cursor on the display device based on the tracked eye movements of the user.

3. The system of claim 1, wherein the stored instructions include instructions that, when executed by the one or more processors, cause the one or more processors to perform operations including:
receiving another interaction with the first key of the keyboard; and
removing display of the cursor from the display device.

4. The system of claim 3, wherein:
receiving the interaction with the first key of the keyboard includes receiving a continuous selection of the first key indicative of the user holding the first key down; and
receiving another interaction with the first key of the keyboard includes receiving an indication that the user has discontinued holding the first key.

5. The system of claim 3, wherein:
receiving the interaction with the first key of the keyboard includes receiving an indication of a press and release of the first key; and
receiving another interaction with the first key of the keyboard includes receiving an indication of another press and release of the first key.

6. The system of claim 1, wherein displaying the cursor with the graphical user interface on the display device includes:
determining an active element of the graphical user interface displayed on the display device; and
displaying the cursor at a center of the active element of the graphical user interface.

7. The system of claim 1, wherein the keyboard includes a second key associated with a first type of selection with the cursor and a third key associated with a second type of selection with the cursor.

8. The system of claim 7, wherein the second key of the keyboard and the third key of the keyboard are each associated with one of a right click with the cursor or a left click with the cursor.

9. The system method of claim 7, wherein the keyboard is a standard QWERTY keyboard and the first key, the second key, and the third key are additional keys that are each dedicated to a single function.

10. The system of claim 7, wherein:
the keyboard is a standard QWERTY keyboard and the first key, the second key, and the third key are keys standard to a QWERTY keyboard; and
receiving the selection of the first key of the keyboard includes receiving the selection of the first key of the keyboard concurrently with selection of a fourth key, the fourth key causing an alternate function of the first key.

11. The system of claim 1, wherein:
tracking non-mouse cursor control inputs of the user includes tracking brain activity of the user; and
moving the cursor on the display device based on the tracked non-mouse cursor control inputs of the user includes moving the cursor on the display device based on the tracked brain activity of the user.

12. A computer-program product, the computer program product comprising computer-readable instructions embodied on tangible, non-transitory computer-readable media, the instructions operable, when executed, to perform operations comprising:
displaying a graphical user interface not including a cursor on a display device;
receiving an interaction with a first key of a keyboard, the first key being associated with display of the cursor;
based on receiving the interaction with the first key, displaying the cursor with the graphical user interface on the display device;
in response to displaying the cursor with the graphical user interface on the display device, tracking non-mouse cursor control inputs of a user; and
moving the cursor on the display device based on the tracked non-mouse cursor control inputs of the user.

13. The computer-program product of claim 12, wherein:
tracking non-mouse cursor control inputs of a user includes tracking eye movements of a user; and
moving the cursor on the display device based on the tracked non-mouse cursor control inputs of the user includes moving the cursor on the display device based on the tracked eye movements of the user.

14. The computer-program product of claim 12, wherein the computer-readable instructions include instructions operable, when executed, to perform operations including:
receiving another interaction with the first key of the keyboard; and
removing display of the cursor from the display device.

15. The computer-program product of claim 12, wherein displaying the cursor with the graphical user interface on the display device includes:
determining an active element of the graphical user interface displayed on the display device; and
displaying the cursor at a center of the active element of the graphical user interface.

16. The computer-program product of claim 12, wherein:
tracking non-mouse cursor control inputs of a user includes tracking brain activity of a user; and
moving the cursor on the display device based on the tracked non-mouse cursor control inputs of the user includes moving the cursor on the display device based on the tracked brain activity of the user.

17. A computer-implemented method comprising:
displaying a graphical user interface not including a cursor on a display device;
receiving an interaction with a first key of a keyboard, the first key being associated with display of the cursor;
based on receiving the interaction with the first key, displaying the cursor with the graphical user interface on the display device;
in response to displaying the cursor with the graphical user interface on the display device, tracking non-mouse cursor control inputs of a user; and
moving the cursor on the display device based on the tracked non-mouse cursor control inputs of the user.

18. The computer-implemented method of claim 17, wherein:
tracking non-mouse cursor control inputs of a user includes tracking eye movements of a user; and
moving the cursor on the display device based on the tracked non-mouse cursor control inputs of the user includes moving the cursor on the display device based on the tracked eye movements of the user.

19. The computer-implemented method of claim 17, further comprising:
receiving another interaction with the first key of the keyboard; and
removing display of the cursor from the display device.

20. The computer-implemented method of claim 17, wherein displaying the cursor with the graphical user interface on the display device includes:
determining an active element of the graphical user interface displayed on the display device; and
displaying the cursor at a center of the active element of the graphical user interface.

21. A system, comprising:
a keyboard including a first key associated with display of a cursor, a second key associated with a first type of selection with the cursor, and a third key associated with a second type of selection with the cursor;
a display device;
one or more processors; and
one or more storage devices storing instructions that, when executed by the one or more processors, cause the one or more processors to perform operations including:
displaying a graphical user interface not including the cursor on the display device,
receiving a first user interaction with the first key of the keyboard,
based on receiving the first interaction with the first key, determining an active element of the graphical user interface displayed on the display device and displaying the cursor at a center of the active element of the graphical user interface,
in response to displaying the cursor, tracking non-mouse cursor control inputs of a user,
based on the tracked non-mouse cursor control inputs of the user, moving the cursor over an element of the graphical user interface displayed on the display device,
receiving a user interaction with either the second key of the keyboard or the third key of the keyboard,
based on receiving the user interaction with either the second key of the keyboard or the third key of the keyboard, executing either a first type of selection or a second type of selection with respect to the element of the graphical user interface over which the cursor is moved,
receiving a second user interaction with the first key of the keyboard, and
based on receiving the second interaction with the first key, hiding the cursor on the display device.

22. The system of claim 21, wherein:
tracking non-mouse cursor control inputs of a user includes tracking eye movements of a user; and
moving the cursor over the element of the graphical user interface includes moving the cursor over the element of the graphical user interface based on the tracked eye movements of the user.

23. The system of claim 21, wherein:
tracking non-mouse cursor control inputs of the user includes tracking brain activity of the user; and
moving the cursor over the element of the graphical user interface includes moving the cursor over the element of the graphical user interface based on the tracked brain activity of the user.

24. The system of claim 21, wherein moving the cursor over the element of the graphical user interface displayed on the display device includes:
determining that the cursor has been moved within a predetermined distance of the element of the graphical user interface displayed on the display device; and
based on determining that the cursor has been moved within a predetermined distance of the element of the graphical user interface, automatically displaying the cursor at the center of the element of the graphical user interface displayed on the display device.
